(19) United States
(12) Patent Application Publication
(10) Pub. No.: US 2013/0088427 A1
(43) Pub. Date: Apr. 11, 2013

(54) MULTIPLE INPUT AREAS FOR PEN-BASED COMPUTING

(71) Applicants: Eric Liu, Santa Clara, CA (US); Stefan J. Marti, Santa Clara, CA (US); Seung Wook Kim, Cupertino, CA (US)

(72) Inventors: Eric Liu, Santa Clara, CA (US); Stefan J. Marti, Santa Clara, CA (US); Seung Wook Kim, Cupertino, CA (US)

(21) Appl. No.: 13/270,403

(22) Filed: Oct. 11, 2011

(51) Int. Cl. G06F 3/033; G06F 3/041

(52) U.S. Cl. 345/157; 345/173; 345/179

(57) ABSTRACT

Embodiments of the present invention disclose a pen-based computing system and method using multiple input areas. According to one embodiment, the system includes a mobile computing device having a display, and a pen input device configured to transmit a signal for determining a position of the pen device relative to the mobile computing device. A plurality of input areas are designated around the entire outer periphery of the display and the mobile computing device such that the presence or movement of the pen input device within any one of the plurality of input areas corresponds to an input operation on the mobile computing device.

### BACKGROUND

The emergence and popularity of mobile computing has made portable electronic devices, due to their compact design and light weight, a staple in today's marketplace. Moreover, providing efficient and intuitive interaction between devices and users thereof is essential for delivering an engaging and enjoyable user-experience. For example, stylus or pen-based input systems provide a natural user interface for computing systems by enabling a specific point on a touch-enabled display screen to be selected or identified when the user physically touches the display with a pointing device or pen stylus.

Though pen-based computing systems offer even more interface options, the screen size of most mobile computing devices limits its effectiveness. Moreover, facilitating on-screen interactions (e.g., nested menus) often consumes a large portion of the display, thereby reducing the amount of display space for viewing content. Still further, occlusion issues may arise due to the pen stylus or the user's fingers blocking viewable portions of the display screen during an on-screen interaction.

### BRIEF DESCRIPTION OF THE DRAWINGS

The features and advantages of the inventions as well as additional features and advantages thereof will be more clearly understood hereinafter as a result of a detailed description of particular embodiments of the invention when taken in conjunction with the following drawings in which:

FIG. 1 is a simplified block diagram of a pen-based computing system in accordance with an example of the present invention.

FIG. 2 is an illustration of the multiple input areas for pen-based computing according to an example of the present invention.

FIGS. 3A and 3B are illustrations of user-oriented rotation and device-oriented rotation for pen-based computing according to an example of the present invention.

FIG. 4 is a three-dimensional perspective view of an operating environment utilizing multiple input areas for pen-based computing on a mobile device according to an example of the present invention.

FIG. 5 is a simplified flow chart of the processing steps in providing multiple input areas for pen-based computing on a mobile device according to an example of the present invention.

### DETAILED DESCRIPTION OF THE INVENTION

The following discussion is directed to various embodiments. Although one or more of these embodiments may be discussed in detail, the embodiments disclosed should not be interpreted, or otherwise used, as limiting the scope of the disclosure, including the claims. In addition, one skilled in the art will understand that the following description has broad application, and the discussion of any embodiment is meant only to be an example of that embodiment, and not intended to intimate that the scope of the disclosure, including the claims, is limited to that embodiment. Furthermore, as used herein, the designators “A”, “B” and “N” particularly with respect to the reference numerals in the drawings, indicate that a number of the particular feature so designated can be included with examples of the present disclosure. The designators can represent the same or different numbers of the particular features.

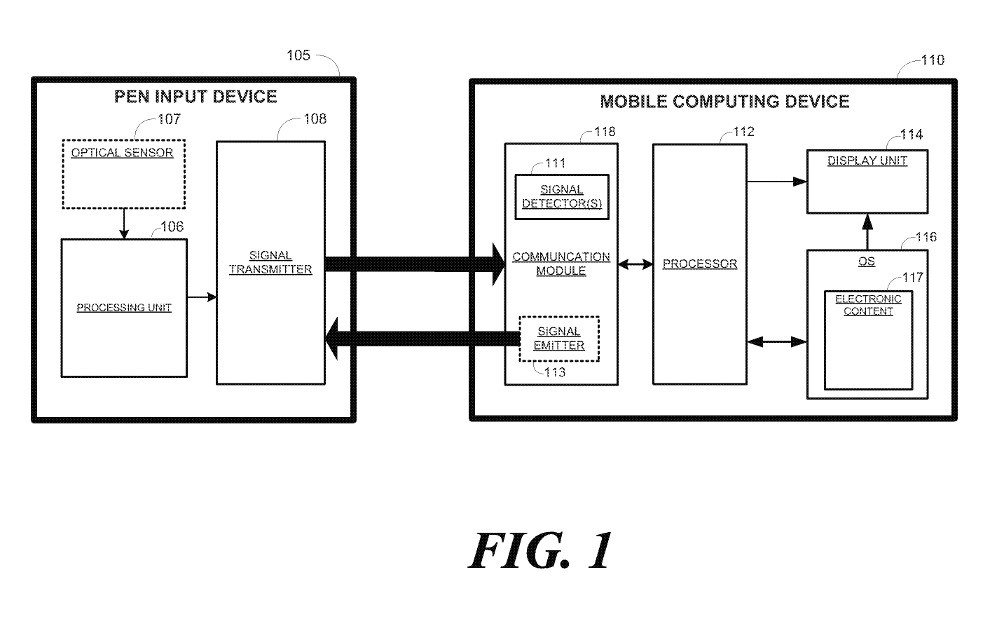

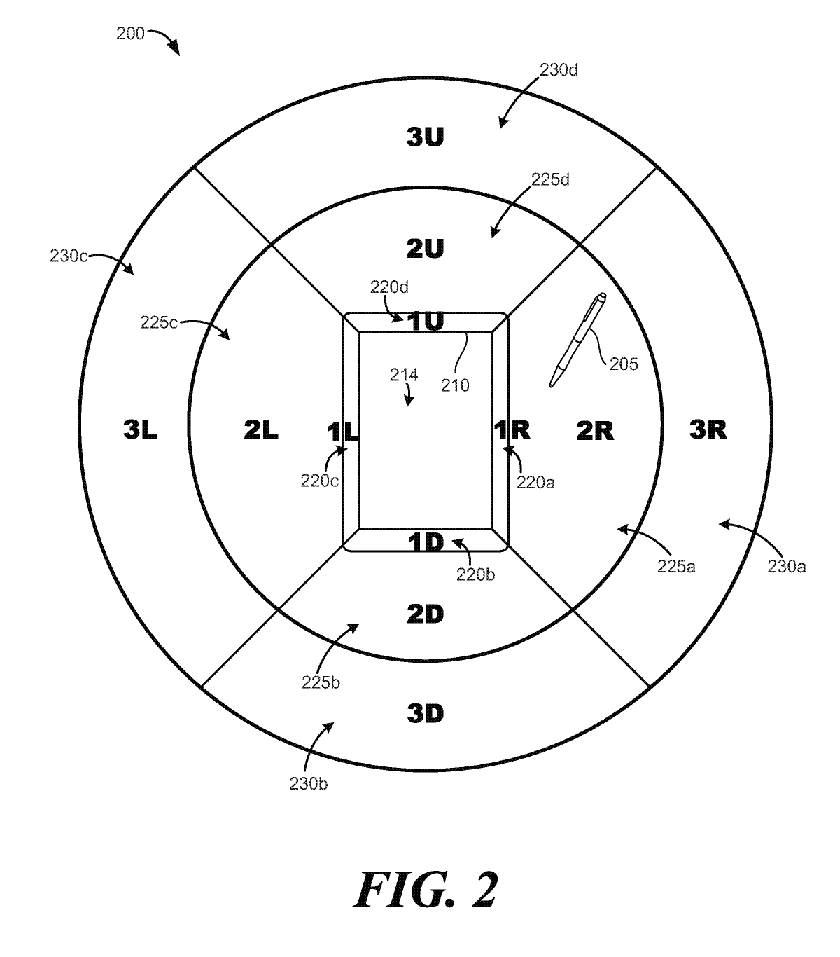

The figures herein follow a numbering convention in which the first digit or digits correspond to the drawing figure number and the remaining digits identify an element or component in the drawing. Similar elements or components between different figures may be identified by the user of similar digits. For example, 143 may reference element “43” in FIG. 1, and a similar element may be referenced as 243 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

Prior attempts to expand input interaction on mobile computing devices have failed to provide an adequate solution to the aforementioned problems. For instance, one solution includes hand gestures, which are simple swipe gestures performed by the operating user while in front of a camera or a proximity sensor associated with the mobile computing device. However, such gesture input is very limited in usage and also lack preciseness since the gestures are made randomly in the air (i.e., undefined area) by the operating user's hand, which may vary in size and shape. Other solutions utilize proximity sensing to extend gesture-based interaction to one region on a single side of the device. However, these solutions fail to accommodate for the accuracy provided by a pen input device, and also fails to expand the interaction field to all surrounding areas of the mobile device.

Embodiments of the present invention disclose a system and method for providing multiple pen input areas for a mobile computing device. According to one example embodiment, the border region and outer area of the mobile computing device are configured to accept pen-based input. Furthermore, both the on-screen and external area position of a pen input device can be measured using off-screen localization techniques (e.g., trilateration-based methods). When a mobile computing device is placed on a surface, the area surrounding the device can be divided into a plurality of interface quadrants. Consequently, pen-based actions within or across any of these quadrants may be mapped to and correspond with a specific input operation for the mobile computing device.

Referring now in more detail to the drawings in which like numerals identify corresponding parts throughout the views, FIG. 1 is a simplified block diagram of a pen-based computing system in accordance with an example of the present invention. As shown in this example, the system 100 includes a pen input device 105 and a mobile computing device 110. The pen input device 105, which may resemble a pen stylus or wand for example, includes a signal transmitter 108 and processing unit 106. The mobile computing device 110 includes a processor 112 coupled to a display unit 114, a mobile operating system 116, and a signal detector 118. In one example embodiment, processor 112 and processing unit 106 represents a central processing unit (CPU), microcontroller, microprocessor, or logic configured to execute programming instructions associated with the mobile device 110 and pen input device 105 respectively. The display unit 114 of the mobile device represents an electronic visual display configured to display images and graphics for viewing by an operating user. The operating system 116 is configured to execute and run software applications and host electronic content 117. As used herein, electronic content 117 represents digital content or media such as word processing documents, online content, digital images, or any other form of electronic content capable of being stored on a storage medium and edited by an operating user. The mobile operating system 116 may also include a graphical user interface for enabling input interaction between an operating user and the mobile device 110. In addition, mobile device 110 includes a communication module 118 for facilitating detection and location of the pen input device 105 as will be explained in further detail below.

The signal transmitter 108 of the pen input device 105 and the signal receiver(s) 111 of mobile computing device may represent several different technologies based on the pen recognition and calculating method being utilized in accordance with examples of the present invention. For instance, when using ultrasonic triangulation, the signal transmitter 108 represents an emitter configured to emit an ultrasonic signal. In the present example, the signal receivers 111 of the mobile computing device 110 may comprise of one or more microphones configured to receive the ultrasonic signal. Such a configuration enables the processor 112 to compute the pen input device's location and movement along one of the determined input areas based on differences in timing, frequency, phase, and/or signal strength of the received ultrasonic signal.

In another example embodiment, radio frequency (RF) triangulation may be utilized for providing pen-based input. Here, the signal transmitter 108 of the pen input device 105 includes an RF emitter configured to transmit an RF signal. Correspondingly, the signal receivers 111 of the mobile computing device 110 may comprise of one or more RF antennas configured to detect the emitted RF signal. Such a configuration enables the processor 112 to compute the pen input device's location and movement along one of the determined input areas based on differences in timing, frequency, phase, and/or signal strength of the received RF signal.

In yet another example embodiment, an infrared triangulation technique may be employed for determining pen-related input activity. For example, the signal transmitter 108 of the pen input device 105 may include an infrared emitter configured to transmit an infrared signal. Here, the signal receivers 111 of the mobile computing device 110 may comprise of one or more infrared detectors/receivers configured to detect the emitted infrared signal. As in the previous examples, the processor 112 may then accurately measure the pen input device's location and movement along one of the determined input areas based on differences in timing, frequency, phase, and/or signal strength of the emitted infrared signal.

Additionally, the pen input device 105 may include an optical sensor 107 for facilitating pen-based computing using interface zones in accordance with an example of the present invention. The optical sensor 107 may be positioned on the pen input device such that when the pen is being held in a normal operating position, the optical sensor 107 points in a downward position so as to face to the mobile computing device 110. In the present example, the optical sensor 107 is configured to capture infrared patterns emitted from a signal emitter 113 of the mobile computing device 110. More particularly, the signal emitter 113 of the mobile computing device 110 may represent infrared proximity emitters configured to project a unique infrared pattern along all sides of the mobile computing device 110. According to one example, the infrared pattern varies in size and/or shape based on the quadrant and distance from the mobile device. For instance, lines of the projected pattern may be further apart on the left side of the device and closer together along the top of the device. By capturing localized features of the IR pattern via the optical sensors 107, the processor 106 of the pen input device may then calculate its position relative to the mobile computing device 110 and forward this positional information to the mobile computing device 110 for determining a corresponding interface quadrant and input operation.

FIG. 2 is an illustration of the multiple input areas for pen-based computing according to an example of the present invention. As shown here, the pen-based computing system 200 includes a plurality of designated input areas including right inner interface zones or quadrants 220a-220d (1R, 1D, 1L, 1U), near interface zones/quadrants 225a-225d (2R, 2D, 2L, 2U), and outer interface zones/quadrants 230a-230d (3R, 3D, 3L, 2U). In one example, the designated interface zones are defined by their radial distance and directional location (i.e., right, left, up, down) with respect to the computing device 210. More particularly, inner interface quadrants 220a-220d represent input areas that lie outside the display 214 but reside on a surrounding border region of the mobile computing device 210. Near interface quadrants 225a-225d represent input areas that are external to both the display 205 and computing device 210, but lie near and adjacent to the surrounding edges of the mobile computing device 210. While outer interface zones 230a-230d represent multiple input areas that are further remote from the computing device 210 than the other quadrants (i.e., 220a-220d and 225a-225d). According to one example, all of the input areas 220a-220d, 225a-225d, and 230a-230d are configured to be coplanar with the display of the mobile computing device 210. Here, processing of pen gestures or movement would occur when the determined position and distance of the pen device lies along the same plane as the mobile device. As such, each interface quadrant will feel like a natural extension of the border region of the mobile computing device. However, examples o the present invention are not limited thereto, as the multiple input areas may also be designated by a non-planar distance away from the display of the mobile computing device 210.

Moreover, various input operations can be attributed to pen-based input within each of these zones as well as when the pen input device 205 crosses in between these zones. For example, circular pen movement within quadrant 220a may cause the displayed or active page to rotate, while downward pen movement between quadrants 225c and quadrant 225b may cause the active page to scroll downward. Furthermore, an undo operation may correspond to a left-to-right pen swipe within zone 220d. That is, a number of input operations including rotation, zoom, cursor movement, text input, gestural shortcuts, application switching, application opening/closing, and similar operations may be mapped to correspond with a pen-based action within or between any one of the above-identified input areas or interface quadrants. Mapping of the input operations to pen interaction may be preconfigured or customized by the operating user. By designating a plurality of input areas involving multiple distance levels (i.e., inner, near, outer) coalesced with multiple radial levels (i.e., right, lower, left, upper), examples of the present invention allows for numerous input operations to be intuitively mapped to particular interface quadrants thus significantly expanding the input functionality for mobile computing devices.

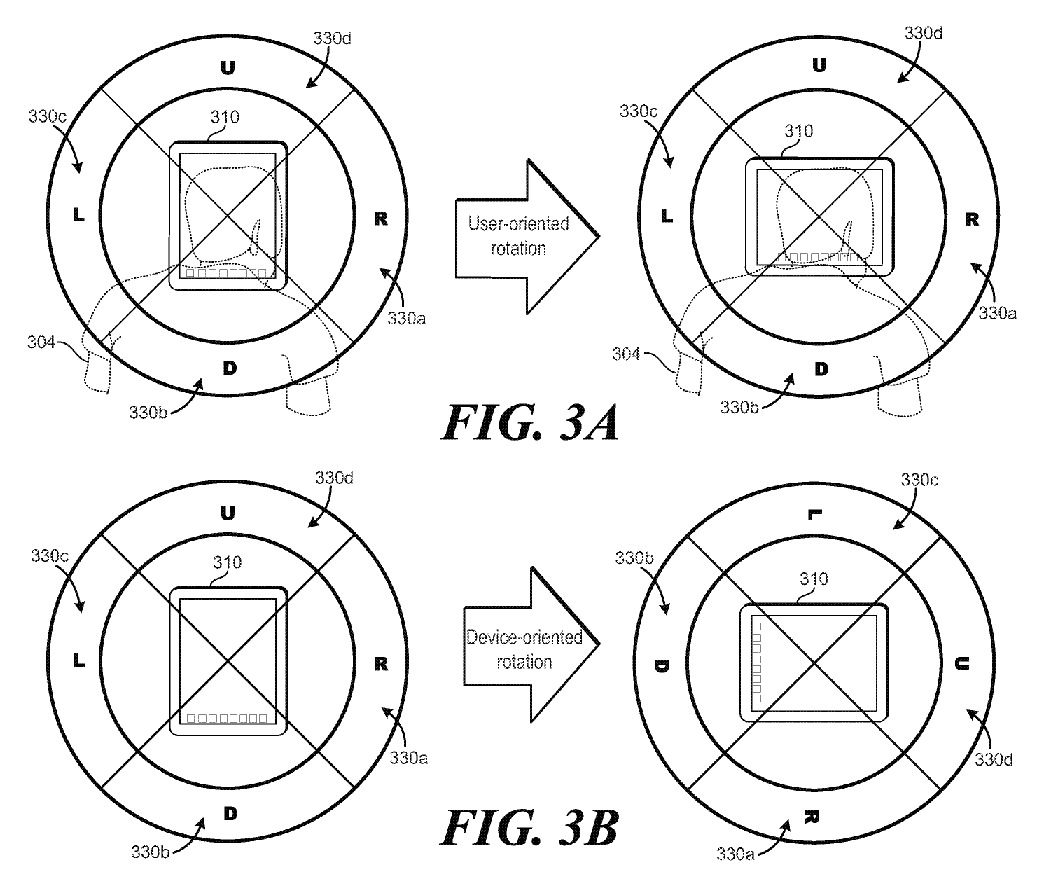

FIGS. 3A and 3B are illustrations of user-oriented rotation and device-oriented rotation for pen-based computing according to an example of the present invention. FIG. 3A represents a device operating in a user-oriented mode. When user-oriented, rotation of mobile computing device 310 does not rotate any of the interface quadrants 330a-330d, as the orientation of the user 304 remains the same. As shown in the right image of FIG. 3A, the mobile computing device has been rotated clockwise, yet the position of the interface quadrants 330a-330d remain the same. In order to detect user-oriented rotation, the mobile computing device 310 may include an inertial sensor (for gravity detection) and/or a front-facing camera (for face detection). Alternatively and as shown in FIG. 3B, the interface zones 320a-320d may be device-oriented, as opposed to user-oriented. Here, clockwise rotation of the computing device 310 causes the interface zones 330a-330d to rotate correspondingly. As shown in the right-most image of FIG. 3B, clockwise rotation of the computing device 310 causes the previous right zone 330a to move to the lower interface quadrant, the previous lower zone 330b to move to the left interface quadrant, the previous left zone 330c to the upper interface quadrant, and the previous upper zone 330d to the right interface quadrant.

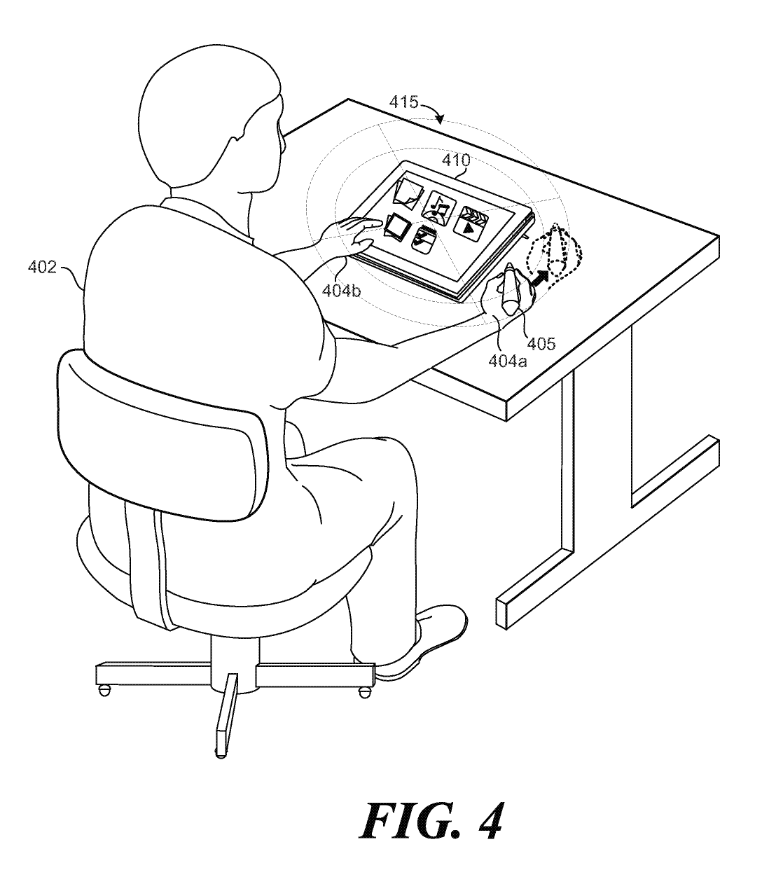

FIG. 4 is a three-dimensional perspective view of an operating environment utilizing multiple input areas for pen-based computing on a mobile device according to an example of the present invention. As shown here, the depiction includes a user 402 operating a mobile computing device 410. The device 410 is positioned stationary on a table surface so as to allow operation from both of the user's hands 404a and 404b. In one hand 404a, the user utilizes a pen device 405 for pen-based input in accordance with the present examples, while the other hand 404b is utilized for basic touch-based input on the surface of the mobile computing device 410. For example, the user may interact directly with the displayed objects (e.g., application selection) using their left hand 404b, while upward movement of the pen input device 405 held in the user's right hand 404a—and within a particular interactive quadrant—causes a separate input operation (e.g., scroll page). That is, since the plurality of input areas 415 lie outside of the touch-enabled display of the computing device, intuitive bi-manual input methods can be implemented—namely one hand for manipulating electronic content on the display screen and the other hand, equipped with the pen input device, used for navigational input.

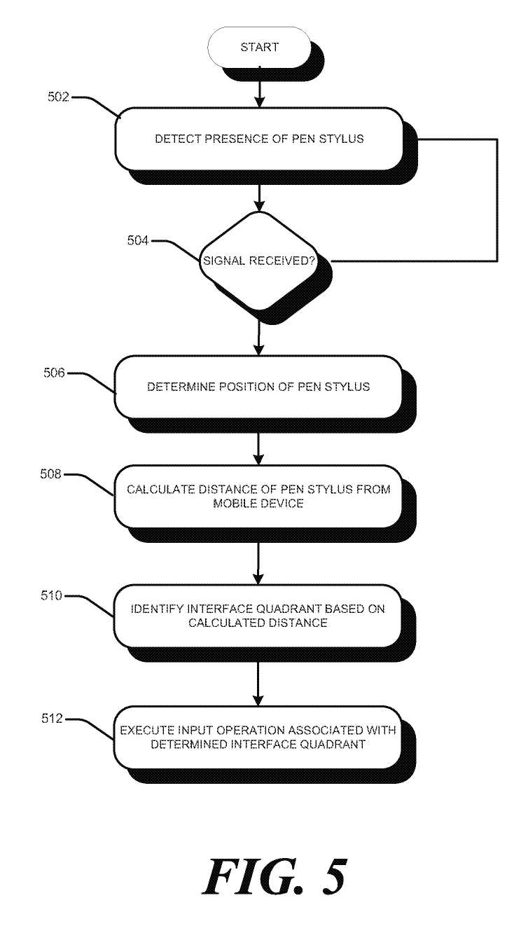

FIG. 5 is a simplified flow chart of the processing steps in providing multiple input areas for pen-based computing on a mobile device according to an example of the present invention. In step 502, the processing unit of the mobile computing device detects the presence of the stylus or pen input device. Thereafter, in step 504, the processing unit determines if a signal is received from the pen input device. As described above, the received signal may be an ultrasound signal, an infrared signal, radio frequency signal, or similar signal capable of establishing positional information of the pen input device. Next, in step 506, the processing unit of the computing device determines the position of the pen input device based on the received signal. The determined positional information is then utilized by the processing unit to compute the distance of the pen stylus from the mobile computing device in step 508. Based on the calculated distance and positional information, the processing unit identifies the target interface quadrant(s) associated with pen input device in step 510. For example, the target interface quadrant may be identified as the upper-near interface zone (2U) when the position and distance information of the pen stylus is determined to be two inches north (based on received signal) of the mobile computing device. Or, if associated with user movement between two adjacent quadrants (2R), the identified target input areas may include both the lower-inner interface zone and lower-near interface zone. Next, an input operation (e.g., scroll page, close application) mapped to and corresponding with the identified target input areas is then executed by the processing unit in step 512.

Examples of the present invention disclose a system and method for pen-based computing using multiple input areas. Moreover, several advantages are afforded in accordance with the examples described herein. For instance, designation of pen interface zones outside the screen area of a mobile device enhances the functionality of the pen input device and effectively increases the interaction area of the pen stylus by an order of magnitude. Moreover, the external pen input areas of the present examples are spatially linked to the device screen creating a logical spatial extension of the mobile device's interaction space. This saves space on the screen and allows the user a very wide area to scroll in. According to one example, the interface zones encompass the entire surrounding area of the mobile computing device thereby preserving the precious real estate of the display screen and drastically reducing the possibility of occlusion issues caused by a user's hand covering a portion of a touch-enabled display.

Furthermore, while the invention has been described with respect to exemplary embodiments, one skilled in the art will recognize that numerous modifications are possible. For example, although exemplary embodiments depict a tablet personal computer as the mobile computing device, the invention is not limited thereto. For example, the mobile computing device may be a laptop, netbook, smartphone, cell phone, digital audio player, electronic book reader, electronic sketch pad, gaming console, or any other portable electronic device configured to interact with a pen input device for providing pen-based computing.

In addition, the multiple interface quadrants of present examples are not limited to the size and shape described above and depicted in the attached figures. For example, the input areas may comprise of multiple rectangular-shaped zones, or only a single surrounding radial layer (e.g., 2U, 2R, 2D, 2L zones) rather than the three expansive layers (i.e., inner, nearer, outer). Furthermore, the writing tool may be formed in any shape or size conducive to handwriting input by an operating user rather than the pen-shaped device depicted in the present examples. For example, the writing tool may be the size and shape of a highlighter, crayon, pencil, brush, or similar writing utensil. Moreover, the mobile computing device may include visual or audible indicators to aid in designating actions taken by the user within the multiple interface zones. Thus, although the invention has been described with respect to exemplary embodiments, it will be appreciated that the invention is intended to cover all modifications and equivalents within the scope of the following claims.

What is claimed is:

1. A pen-based computing system comprising:
a mobile computing device having a display; and
a pen input device configured to transmit a signal for determining a position of the pen input device relative to the mobile computing device,
wherein a plurality of input areas are designated around the entire outer periphery of the display and mobile computing device, and
wherein presence or movement of the pen input device within any one of the plurality of input areas corresponds to an input operation on the mobile computing device.

2. The system of claim 1, wherein the input areas includes an upper quadrant, lower quadrant, right quadrant, and left quadrant.

3. The system of claim 2, wherein the input areas are designated based on a radial distance away from the mobile computing device in the same plane as display.

4. The system of claim 1, wherein the input areas include both a surrounding border area and a surrounding external area of the mobile computing device.

5. The system of claim 4, where the plurality of input areas are coplanar with the display of the mobile computing device.

6. The system of claim 1, wherein the pen input device includes a speaker that emits an ultrasonic signal, and
wherein the mobile computing device is configured to detect differences in timing, frequency, phase, and/or signal strength of said signal to determine a location and movement of the pen input within one of the plurality of designated input areas.

7. The system of claim 1, wherein the pen input device includes a radio frequency emitter configured to transmit a radio frequency signal, and
wherein the mobile computing device is configured to detect differences in timing, phase, frequency, and/or signal strength of said radio frequency signal in order to determine a location and movement of pen input device within one of the plurality of designated input areas.

8. The system of claim 1, wherein the pen input device includes an infrared emitter that emits an infrared signal, and
wherein the mobile computing device is configured to detect differences in timing, phase, frequency, and/or signal strength in order to determine a location and movement of pen input device within one of the plurality of designated input areas.

9. The system of claim 1, wherein the pen input device includes an optical sensor configured to detect an infrared pattern projected from the mobile computing device, and
wherein the pen input device determines a position with respect to the mobile computing device based on the detected pattern.

10. The system of claim 1, wherein the corresponding user input includes scrolling a displayed page, undoing a previous action, rotating content, zooming in on content, moving a cursor or pointer, writing text, performing a gestural shortcut action, switching between applications, or closing an application.

11. A method for pen-based computing on a mobile device having a display, the method comprising:
detecting the presence of the pen stylus proximate to one of a plurality of input zones associated with the mobile device, wherein the plurality of input zones are designated around the entire outer periphery of the display and mobile device;
determining a directional position of the pen stylus based on a signal emitted from the pen stylus;
calculating a radial distance of the pen stylus from the mobile computing device based on the determined position;
identifying at least one designated input zone from the plurality of input zones based on the calculated distance; and
executing an input operation associated with the at least one designated input zone.

12. The method of claim 11, further comprising:
receiving an ultrasound signal from the pen input device; and
analyzing differences in timing, frequency, phase, and/or signal strength of said ultrasound signal to determine a location and movement of the pen input within one of the plurality of input zones.

13. The method of claim 11, further comprising:
receiving a radio frequency signal transmitted by a radio frequency emitter of the pen input device, and
analyzing differences in timing, frequency, phase, and/or signal strength of said radio frequency signal in order to determine a location and movement of the pen input device within one of the plurality of input zones.

14. The method of claim 11, further comprising:
receiving an infrared signal from the pen input device, and
analyzing differences in timing, frequency, phase, and/or signal strength in order to determine a location and movement of the pen input device within one of the plurality of input zones.

15. The method of claim 11, further comprising:
emitting an infrared pattern from the mobile computing device, and
receiving positional information associated with the pen input device,
wherein the positional information is determined based on detection of the infrared pattern by an optical sensor of the pen input device.

16. A pen-based computing system comprising:
a mobile computing device having a touch-enabled display, wherein the mobile computing device includes a plurality of interface quadrants designated around the entire outer periphery and coplanar of the touch-enabled display, and
a pen input device configured to transmit a signal for determining a position of the pen input device relative to the mobile computing device,
wherein the plurality of interface quadrants include an upper quadrant, lower quadrant, right quadrant, and left quadrant,
wherein the plurality of interface quadrants are designated based on a radial distance away from the mobile computing device, and
wherein the presence or movement of the pen input device within any of the plurality of interface quadrants corresponds to an input operation on the mobile computing device.

17. The system of claim 16, wherein the pen input device includes a speaker that emits an ultrasonic signal, and
wherein the mobile computing device is configured to detect differences in timing, frequency, phase, and/or signal strength of said signal to determine a location and movement of the pen input within one of the plurality of designated input areas.

18. The system of claim 16, wherein the pen input device includes a radio frequency emitter configured to transmit a radio frequency signal, and
wherein the mobile computing device is configured to detect differences in timing, frequency, phase, and/or signal strength of said radio frequency signal in order to determine a location and movement of pen input device within one of the plurality of designated input areas.

19. The system of claim 16, wherein the pen input device includes an infrared emitter that emits an infrared signal, and
wherein the mobile computing device is configured to detect differences in timing, frequency, phase, and/or signal strength in order to determine a location and movement of pen input device within one of the plurality of designated input areas.

20. The system of claim 16, where the plurality of interface quadrants areas are coplanar with the touch-enabled display of the mobile computing device.
